(19) United States
(12) Patent Application Publication
(10) Pub. No.: US 2020/0026576 A1
(43) Pub. Date: Jan. 23, 2020

(54) DETERMINING A NUMBER OF NODES REQUIRED IN A NETWORKED VIRTUALIZATION SYSTEM BASED ON INCREASING NODE DENSITY

(71) Applicant: Nutanix, Inc., San Jose, CA (US)

(72) Inventor: Steven KAPLAN, Stateline, NV (US)

(73) Assignee: Nutanix, Inc., San Jose, CA (US)

(21) Appl. No.: 15/410,308

(22) Filed: Jan. 19, 2017

(51) Int. Cl. G06F 9/50; G06F 9/455; G06F 17/30; G06Q 10/06

(52) U.S. Cl. CPC G06F 9/5077; G06F 9/45558; G06F 2009/45595; G06Q 10/06313; G06F 17/30339

(57) ABSTRACT

An architecture for implementing a system planner for determining a number of nodes required in a networked virtualization system based on increasing node density is provided. The system planner receives various inputs describing a current networked virtualization system, an analysis period during which the workload of the current networked virtualization system is expected to increase, and a projected increase in node density during the analysis period. Based on the inputs, the system planner generates a new configuration of the networked virtualization system that includes a number of new nodes that are added to the current networked virtualization system to provide the resources necessary to support the increase in workload during the specified analysis period.

### CROSS REFERENCE TO RELATED APPLICATIONS

The present application is related to U.S. Pat. No. 8,601,473, entitled “ARCHITECTURE FOR MANAGING I/O AND STORAGE FOR A VIRTUALIZATION ENVIRONMENT,” which is hereby incorporated by reference in its entirety.

### FIELD

This disclosure concerns a method, a computer program product, and a computer system for determining a number of nodes required in a networked virtualization system based on increasing node density.

### BACKGROUND

A networked virtualization system includes a number of nodes (e.g., hyperconverged systems that integrate compute and storage), in which each node services or “supports” a number of virtual machines and each node has local storage as well as cloud storage or networked storage. The number of virtual machines that may be supported by a node is dependent on its resource capacity (e.g., memory, CPU, and scheduling limitations specific to the node). A node may support a maximum number of virtual machines before end users experience degradation in performance. As an organization or other entity utilizing the networked virtualization system expands, the number of virtual machines it requires may approach this maximum number. To avoid the risk of experiencing any detrimental effects on performance of the networked virtualization system that may arise due to overtaxing of available resources, additional nodes may be incorporated into the networked virtualization system to support additional virtual machines.

Capacity planning is a process conventionally used to help determine the number of additional nodes to add when expanding a networked virtualization system. The steps of capacity planning typically involve identifying the nodes to be involved in the planning, determining current resource usage (e.g., based on historical compute and storage usage data), determining projected resource requirements during a particular timeframe, and determining a capacity solution (e.g., a configuration that describes the nodes to be added to the networked virtualization system) that is capable of handling the projected resource requirements). Based on the capacity solution, an organization may implement a plan to purchase additional nodes.

The projected resource requirements on which a capacity solution is based are determined in anticipation of future needs, often several years down the line. However, due to ongoing improvements in hardware, any determination of the number of additional nodes required to fulfill projected resource requirements is likely to be overestimated. Such overestimates will incur additional costs of the nodes that could have been avoided (e.g., cost of the nodes themselves, cost of rack space to house the nodes, power and cooling costs, etc.). Not only does this increase the total cost of ownership (TCO) of the networked virtualization system for an organization, but this also decreases the organization's return on investment (ROI).

Therefore, there is a need for an improved approach for anticipating the number of nodes required in a networked virtualization system.

### SUMMARY

Embodiments of the present invention provide a method, a computer program product, and a computer system for determining a number of nodes required in a networked virtualization system based on an increasing “node density” (i.e., a number of virtual machines that may be supported by each node) in the networked virtualization system.

According to some embodiments, a system planner is implemented to evaluate a current networked virtualization system (“current system”) and to generate a new configuration of the networked virtualization system. The new configuration of the networked virtualization system (“new system”) includes a number of new nodes that are added to the current system in anticipation of future increases in resource requirements during a specified analysis period. The system planner includes a density analysis module and a system planning unit. The density analysis module determines the node density of the current system as well as the projected increase in node density during the specified analysis period. Using the node density of the current system, the projected increase in node density, one or more planning algorithms, and various additional inputs, the system planning unit may determine a new configuration of the networked virtualization system.

Further details of aspects, objects and advantages of the invention are described below in the detailed description, drawings and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1 illustrates an apparatus including a system planner in which some embodiments of the invention are implemented.

FIG. 2 illustrates a system planner according to some embodiments of the invention.

FIGS. 3A-3C illustrate example tables for determining a number of virtual machines supported by each node in a networked virtualization system according to some embodiments of the invention.

FIG. 4 is a flowchart illustrating operation of an input stage, an analysis stage, and an output stage performed by a system planner according to some embodiments of the invention.

FIG. 5 is a flow chart illustrating a method for determining a number of nodes required in a networked virtualization system according to some embodiments of the invention.

FIG. 6 is a flow chart illustrating a method for determining resource requirements associated with a configuration of a networked virtualization system according to some embodiments of the invention.

FIG. 7A illustrates an example networked virtualization system for system planning according to some embodiments of the invention.

FIG. 7B illustrates an alternative example networked virtualization system for system planning according to some embodiments of the invention.

FIG. 8 illustrates a system to implement a virtualization management console according to some embodiments of the invention.

FIG. 9 illustrates a computing environment having multiple underlying systems/clusters to be managed, where a separate management node exists for each of the underlying systems/clusters.

FIG. 10 is a block diagram of a computing system suitable for implementing an embodiment of the present invention.

### DETAILED DESCRIPTION OF THE EMBODIMENTS OF THE INVENTION

The present disclosure provides an improved approach to determine a number of nodes required in a networked virtualization system.

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

A networked virtualization system (herein after referred to as a “system”) includes a number of nodes (e.g., servers, hypercoverged systems that integrate compute and storage, etc.), each node supporting a number of virtual machines and each node having several units of local storage (e.g., Solid State Drives (“SSDs”) and Hard Disk Drives (“HDDs”) as well as cloud storage or networked storage (e.g., a storage area network (“SAN”)). The number of virtual machines that a node may support is dependent on its resource capacity. For example, a node may support a maximum number of virtual machines based on the node's available memory and CPU, and based on scheduling limitations specific to the node.

A “virtual machine” or a “VM” refers to a specific software-based implementation of a machine in a virtualization environment, in which the hardware resources of a real computer (e.g., CPU, memory, etc.) are virtualized or transformed into the underlying support for the fully functional virtual machine that can run its own operating system and applications on the underlying physical resources, just like a real computer. Virtualization works by inserting a thin layer of software directly on the computer hardware or on a host operating system. This layer of software contains a virtual machine monitor or “hypervisor” that allocates hardware resources dynamically and transparently. Multiple operating systems run concurrently on a single physical computer and share hardware resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them.

Virtualization allows multiple virtual machines to run on a single physical machine, with each virtual machine sharing the resources of that one physical computer across multiple environments. Different virtual machines can run different operating systems and multiple applications on the same physical computer. One reason for the broad adoption of virtualization in modern business and computing environments is because of the resource utilization advantages provided by virtual machines. Without virtualization, if a physical machine is limited to a single dedicated operating system, during periods of inactivity by the dedicated operating system, the physical machine is not utilized to perform useful work. This is wasteful and inefficient if there are users on other physical machines, which are currently waiting for computing resources. To address this problem, virtualization allows multiple VMs to share the underlying physical resources so that during periods of inactivity by one VM, other VMs can take advantage of the resource availability to process workloads. This can produce great efficiencies for the utilization of physical devices, and can result in reduced redundancies and better resource cost management.

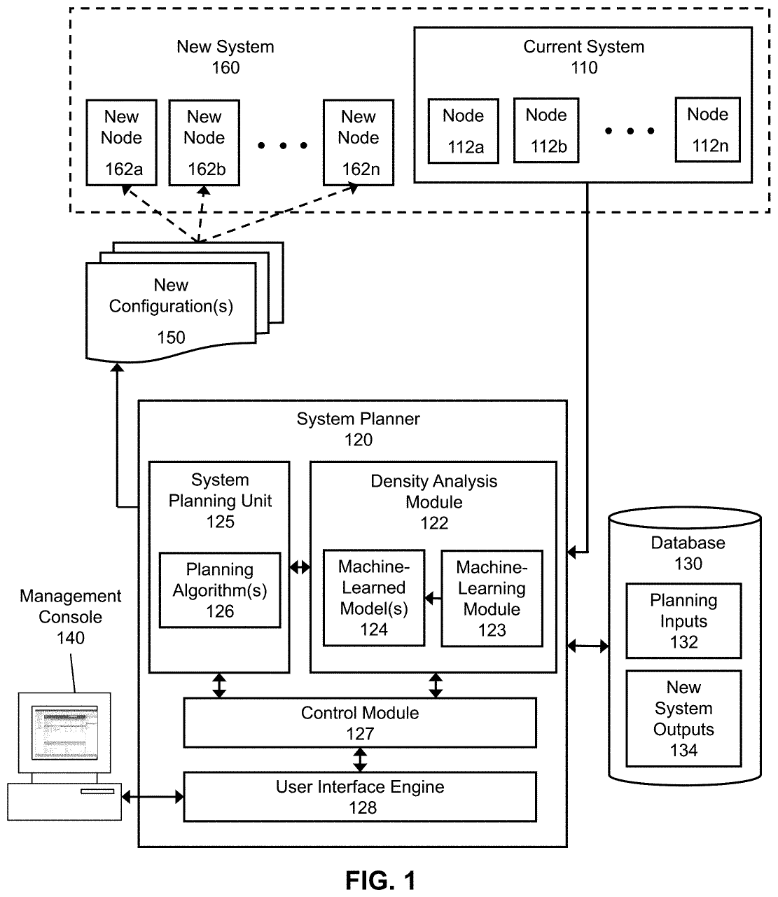

FIG. 1 illustrates an apparatus including a system planner in which some embodiments of the invention are implemented. In various embodiments, some aspects of the embodiments may be implemented separately or as a whole.

A system planner 120 receives one or more inputs describing a current system 110 that contains multiple nodes 112a-n, each of which support a number of VMs. The system planner 120 may receive additional inputs describing anticipated requirements to be met during a specified analysis period (e.g., a number of VMs anticipated to be required), a projected increase in node density during the analysis period, and restrictions or rules to which a new configuration 150 of the system must comply. The information included in some or all of these inputs may be received from a user (e.g., a system administrator) via a management console 140. Alternatively, the information included in some or all of these inputs may be included in a set of planning inputs 132 retrieved from a database 130.

Based on information describing the current system 110, the anticipated requirements to be met by the system during the analysis period, and the projected increase in node density during the analysis period, the system planner 120 determines one or more potential new configuration(s) 150 of the system. Each of the new configuration(s) 150 of the system describes one or more new nodes 162a-n that may be added to the current system 110 to create a new system 160 that will support the anticipated requirements to be met during the analysis period. Information describing the new configuration(s) 150 may be presented to a system administrator or other user (e.g., via the management console 140) and/or stored as a new system output 134 in the database 130 (e.g., for later retrieval and evaluation). Upon approval or selection of a new configuration 150 by the system administrator, the new nodes 162a-n corresponding to the new configuration 150 may be added to the nodes 112a-n of the current system 110 to create the new system 160.

The system planner 120 includes a density analysis module 122. In embodiments in which a current system 110 is in place (i.e., at least one node 112 exists in the system), the density analysis module 122 may determine the node density of the current system 110 (i.e., the number of VMs that may be supported by the nodes 112a-n of the current system 110). The density analysis module 112 may also determine the projected increase in node density during the specified analysis period. For example, the density analysis module 122 may include a machine-learning module 123 that trains one or more machine-learned model(s) 124. The machine-learned model(s) 124 may be used to determine the projected increase in node density during the specified analysis period. In some embodiments, the density analysis module 122 may receive or retrieve explicit information describing the node density of the current system 110 and/or the projected increase in node density (e.g., from a system administrator or retrieved from the database 130).

The system planner 120 also includes a system planning unit 125. The system planning unit 125 may determine one or more new configuration(s) 150 of the system based on the node density of the current system 110 (if one is in place), various inputs received/retrieved by the system planner 120, and the projected increase in node density. The system planning unit 125 may use one or more planning algorithms 126 to determine a new configuration 150 of the system.

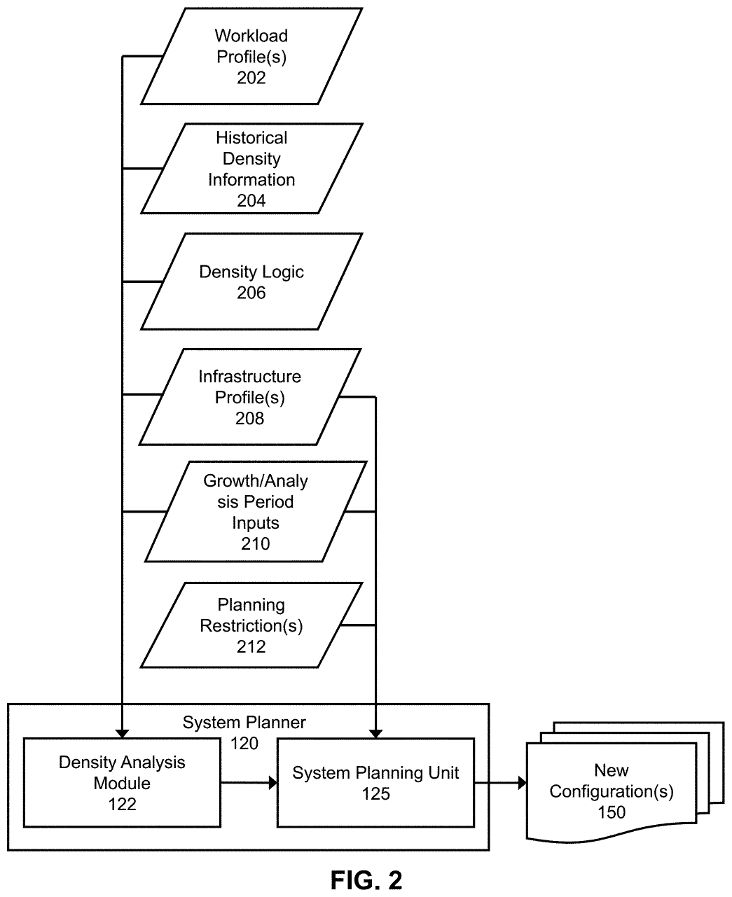

In some embodiments, the system planning unit 125 may select different planning algorithms 126 to implement based on the inputs received/retrieved by the system planner 120 and/or based on the projected increase in node density. For example, a particular planning algorithm 126 may be used if there is no current system 110 in place (e.g., a new configuration 150 of the system determined by the system planner 120 will be the configuration for the first system purchased by an organization), while another planning algorithm 126 may be used if at least one node 112 exists in the current system 110. As an additional example, the planning algorithm 126 used by the system planning unit 125 may be selected based on restrictions to which the new system 160 must comply (e.g., maximum memory and minimum cost requirements). The density analysis module 122 and system planning unit 125, as well as their inputs, are further described below in conjunction with FIG. 2.

The system planner 120 may also include a control module 127 and a user interface engine 128 to interface with the density analysis module 122 and system planning unit 125. For example, the control module 127 may be used to coordinate the receipt of inputs, the output and storage of new configuration(s) 150, and the implementation of rules or commands and processing of data received via the user interface engine 128 or from the database 130. The user interface engine 128 allows a system administrator or other user to interact with the system planner 120 either remotely or via a local instance of the system planner 120, such as through a traditional application interface or via the management console 140 for remote management of the system planner 120.

The database 130 may comprise any combination of physical and logical structures as is ordinarily used for database systems, such as Hard Disk Drives (HDDs), Solid State Drives (SSDs), logical partitions and the like. The database 130 is illustrated as a single database containing planning inputs 132 and new system outputs 134. However, the database 130 may be associated with a cluster that is separate and distinct from the system planner 120. Further, the database 130 may be accessible via a remote server or the database 130 may include multiple separate databases that contain some portion of the planning inputs 132 and/or new system outputs 134.

In various embodiments, the system planner 120 may be associated with or operate on more than one cluster, such that the current system 110 and the new system 160 correspond to multiple current clusters of nodes 112a-n and multiple new clusters of nodes 162a-n, respectively. In embodiments in which several clusters are included in the current system 110, the system planner 120 may analyze each cluster separately. Furthermore, in such embodiments, multiple clusters may interface with one or more databases, such as database 130, that contain locations for storing or retrieving relevant planning inputs 132 or new system outputs 134. In one embodiment, the system planner 120 is a management application or is part of a management application that may be used to manage the one or more clusters and allows the system planner 120 to interface with the one or more clusters or provides a means for operating the system planner 120. For instance, the management application may allow the system planner 120 to access one or more databases on one or more clusters for retrieval and storage of data.

Some embodiments may be implemented on one or more management consoles 140, user stations, or other devices that include any type of computing station that may be used to operate or interface with the system planner 120. Examples of such management consoles 140, user stations, and other devices include, for example, workstations, personal computers, servers, or remote computing terminals. Management consoles 140 may also include one or more input devices for a user to provide operational control over the activities of the system, such as a mouse or keyboard to manipulate a pointing object in a graphical user interface. The system planner 120 may operate on a management console 140 for a plurality of systems or may operate on one or more management consoles 140 distributed across the systems. Further details regarding methods and mechanisms for implementing the virtualization system illustrated in FIG. 1 are described in U.S. Pat. No. 8,601,473, which is hereby incorporated by reference in its entirety.

FIG. 2 illustrates a system planner 120 according to some embodiments of the invention. The system planner 120 comprises two main components that work to determine one or more potential new configuration(s) 150 of the system. As described above, the density analysis module 122 may determine the node density of the current system 110 (if one is in place) and the projected increase in node density during the specified analysis period, while the system planning unit 125 determines the new configuration(s) 150 based on the node density of the current system 110, the projected increase in node density, inputs describing the current system 110, and the anticipated requirements to be met during the analysis period. However, various aspects of the embodiments may be implemented separately or as a whole.

As shown in FIG. 2, various possible inputs to the density analysis module 122 (workload profile(s) 202, historical density information 204, density logic 206, infrastructure profile(s) 208, and growth/analysis period inputs 210) may be used to determine the node density of the current system 110 and the projected increase in node density during the specified analysis period. While these inputs are not all required, the received inputs provide information that may be used to determine the node density of the current system 110 and/or the projected increase in node density during the specified analysis period.

The inputs to the density analysis module 122 may be received from multiple sources. For instance, the workload profile(s) 202, historical density information 204, and infrastructure profile(s) 208 may be retrieved from the database 130, while the density logic 206 and growth/analysis period inputs 210 may be received from a user. In some embodiments, if multiple inputs are available, a user may select the inputs that are used by the density analysis module 122. For example, a system administrator may specify a particular subset of available workload profile(s) 202 that is used by the density analysis module 122 to determine the node density of the current system 110. This provides for increased flexibility for an administrator to control the information used by the density analysis module 122.

Workload profile(s) 202 describe one or more functions or characteristics of workloads of the current system 110. For example, a given workload profile 202 may describe some number of users supported by a Virtual Desktop Interface or an exchange server in the current system 110. As an additional example, workload profile(s) 202 may describe an amount of memory, CPU, or storage required by one or more nodes 112a-n of the current system 110 to support a given number of VMs. Workload profile(s) 202 may be determined by evaluating the workloads of nodes 112a-n of the current system 110 over a period of time, which may subsequently be recorded in one or more automatically or manually generated user editable documents or files that are stored and later retrieved by the density analysis module 122 (e.g., from a database 130).

Historical density information 204 describes a number of virtual machines supported by each node 112 of the current system 110 during a given time period. Historical density information 204 may include a number of VMs actually supported by one or more nodes 112a-n of the current system 110 and/or an estimated number of VMs capable of being supported by the nodes 112a-n based on historical workloads assigned to the nodes 112a-n. For example, historical density information 204 may indicate that during a given time period, a node 112 of the current system 110 supported eight VMs. Based on the average amount of resources (e.g., CPU, memory, and storage) required by the eight VMs and an amount of resources still available on the node 112, an estimate may be made as to the number of additional VMs the node 112 is capable of supporting. Like the workload profile(s) 202, the historical density information 204 may also be recorded in one or more automatically or manually generated user editable documents or files that may be stored and later retrieved by the density analysis module 112 (e.g., from a database 130).

Infrastructure profiles 208 describe various characteristics of infrastructure comprising the current system 110. For example, infrastructure profiles 208 may describe memory, CPU, or storage capacities of each node 112a-n of the current system 110 to support a given number of VMs. Infrastructure profiles 208 may be determined by evaluating the nodes 112a-n of the current system 110. During this evaluation, the infrastructure profiles 208 may be recorded in one or more automatically or manually generated user editable documents or files that are stored and later retrieved by the density analysis module 122 (e.g., from a database 130).

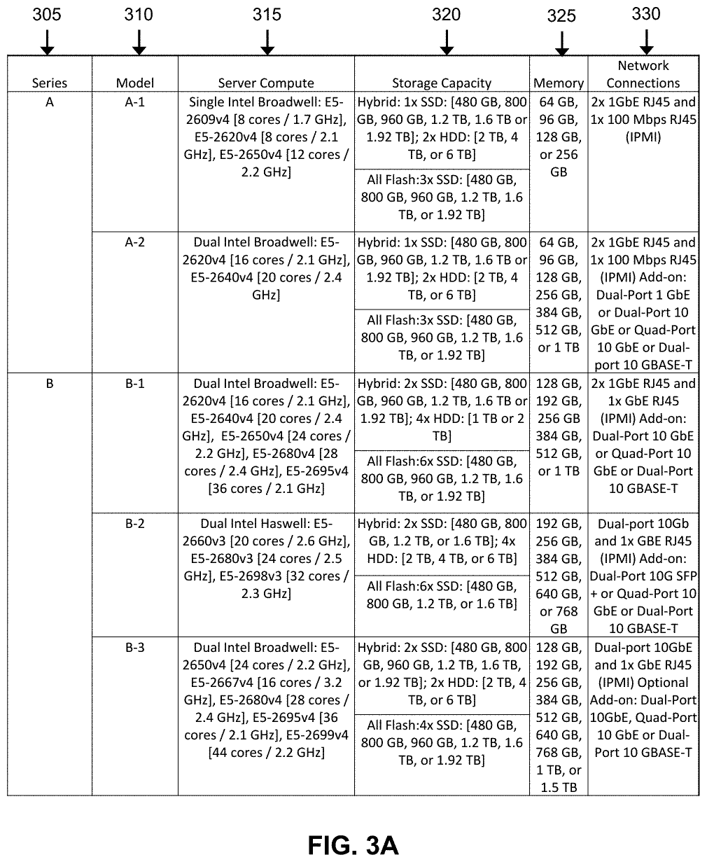

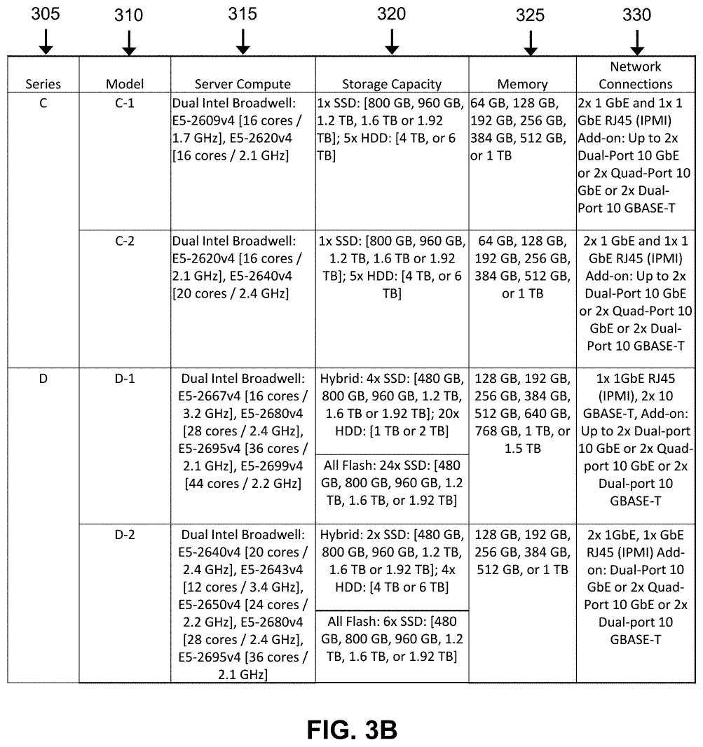

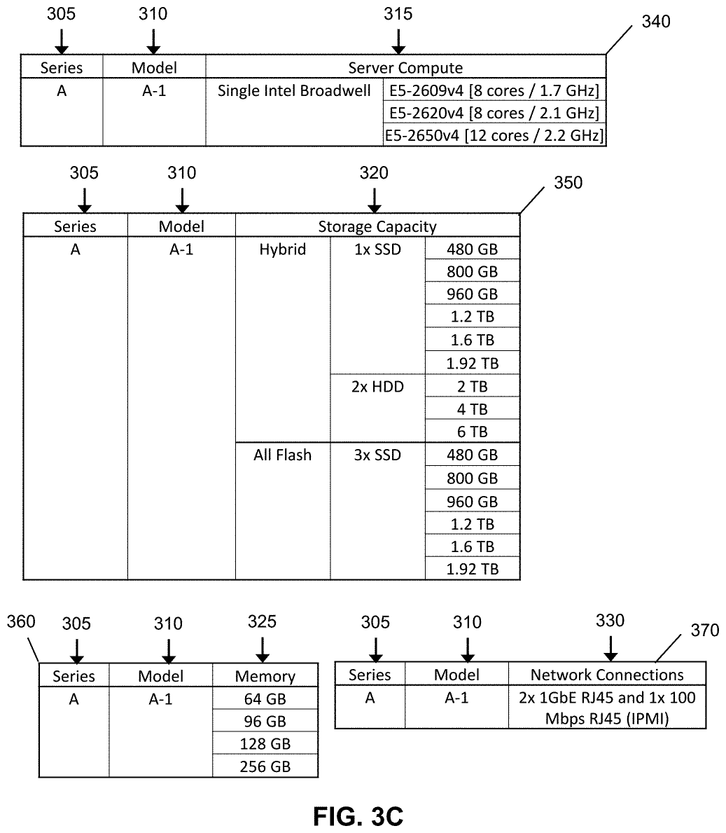

In some embodiments, the infrastructure profiles 208 may include characteristics of infrastructure that do not comprise the current system 110, but which may be added to the current system 110 to generate the new system 160. As shown in FIGS. 3A-3C, infrastructure profile(s) 208 may include one or more database tables that include multiple columns describing resources or other characteristics of different types of nodes that are included in the current system 110 or that may be added to the current system 110. Each row of the tables describes the server compute 315, storage capacity 320, memory 325, and network connections 330 available for different types of nodes based on a series 305 and model 310 of a given node. For example, given the node series 305 B, three different node models 310 are available (B-1, B-2, and B-3) that each corresponds to a subset of different types of different server compute 315, storage capacity 320, memory 325, and network connections 330 available for the given model 310.

In various embodiments, information describing each characteristic of a type of node may be stored in a separate database table. For example, as illustrated in FIG. 3C, the server compute 315 storage capacity 320, memory 325, and network connections 330 available for a particular series 305 and model 310 of node (here, series A and model A-1) are each shown in separate tables 340-370. Each of the columns of these separate tables 340-370 may describe progressively more specific information (e.g., a set of subtypes or constraints) pertaining to the corresponding resources or characteristics. For example, for each row of table 350, the storage capacity 320 for the A-1 model 310 of the A series 305 may first be described as being hybrid or all flash. Next, the hybrid storage may be 1× SSD or 2× HDD, while all flash may be 3× SSD. Then, 1× SSD and 3× SSD may correspond to 480 GB, 800 GB, 960 GB, 1.2 TB, 1.6 TB, or 1.92 TB of storage, while the 2× HDD may correspond to 2 TB, 4 TB, or 6 TB of storage. Therefore, each type of storage is associated with a subtype of storage, which in turn, is associated with a set of constraints on storage availability. The other database tables 340, 360, 370 of FIG. 3C illustrate similar subtypes and/or constraints on available resources of the same type of node just described.

Referring again to FIG. 2, the growth/analysis period inputs 210 comprise various inputs pertaining to the analysis period for which the new configuration(s) 150 of the system are to be determined by the system planner 120. The growth/analysis period inputs 120 may be provided by a system administrator or other user and include at least one input describing the analysis period during which the density analysis module 122 may determine a projected increase in node density. For example, an input may describe a number of months or years from a present time during which the number of virtual machines required to be supported by the system is expected to grow.

The growth/analysis period inputs 210 may also include information describing a number of VMs expected to be required by the end of the analysis period. In some embodiments, the number of VMs expected to be required by the end of the analysis period is determined based on trends determined from the historical density information 204. For example, the machine-learning module 123 of the density analysis module 112 may train a machine-learned model 124 using historical information describing different numbers of virtual machines deployed at various times on one or more nodes 112a-n of the current system 110 to predict a number of virtual machines expected to be required at the end of the analysis period. As an additional example, the machine-learning module 123 may train a machine-learned model 124 to estimate the number of VMs that will be required by the end of the analysis period based on various trends or observations that may be obtained by sampling information from the workload profile(s) 202 over a period of time.

When executed, the density analysis module 122 provides an implementation of the density logic 206 with respect to the other inputs received by the density analysis module 122 to determine the node density associated with the current system 110 and/or the projected increase in node density during the specified analysis period. The density logic 206 comprises some set of rules, logic, and/or analysis to apply, whereas the workload profile(s) 202, the historical density information 204, the infrastructure profile(s) 208, and the growth/analysis period inputs 210 comprise one or more sets of parameters on which the density logic 206 is intended to operate. Therefore, the density analysis module 122 may provide different and/or multiple implementations of the density logic 206 based on the types of inputs received by the density analysis module to determine the node density associated with the current system 110 and/or the projected increase in node density during the specified analysis period. For example, in embodiments in which a system administrator may provide an input that includes the projected increase in node density (e.g., as part of the growth/analysis period inputs 210), the density logic 206 may dictate that when provided, this value should be used as the projected increase in node density for the current analysis being performed by the system planner 120 (rather than determining the projected increase in node density). As an additional example, if no historical density information 204 is provided, the density logic 206 may dictate that no current system 110 is in place (i.e., that the node density of the current system 110 has a value of 0 or null).

In various embodiments, an administrator may be permitted to select the density logic 206 implemented by the density analysis module 122 to determine the node density of the current system 110 and/or the projected increase in node density during the specified analysis period. For example, a system administrator may specify that only historical density information 204 associated with a date that is within the past six years or associated with a particular type of node (e.g., nodes having a specific type of network connection) should be used as inputs for the density analysis module 122. In some embodiments, an administrator or other user may select or provide additional types of inputs used by the density analysis module 122. For example, if multiple projected increases in node density that are based on different observations or theories are possible (e.g., Moore's law), options may be presented in a graphical user interface allowing a user to provide an input (e.g., via the management console 140) to select one or more possible observations or theories. The selection(s) may then be used by the density analysis 122 on which to base the projected increase(s) in node density.

In some embodiments, a parsing step may be performed (e.g., by the control module 127) to verify that the required and/or optional parameters in the density logic 206 are included in the workload profile(s) 202, the historical density information 204, the infrastructure profile(s) 208, and/or the growth/analysis period inputs 210. In this way, the density analysis module 122 may ensure that the density logic 206 can actually be applied using a given set of inputs to determine the node density of the current system 110 and/or the projected increase in node density during the specified analysis period. Parsing may include verification of intermediary variables provided in the density logic 206 itself, in the event that they are not included in the workload profile(s) 202, the historical density information 204, the infrastructure profile(s) 208, and/or the growth/analysis period inputs 210.

In embodiments in which the a current system 110 is in place, the density analysis module 122 may provide implementations of the density logic 206 with respect to the associated workload profile(s) 202, historical density information 204, and infrastructure profile(s) 208 to determine a node density associated with the current system 110. The density logic 206 may describe various types of logic for determining different types of node densities associated with the current system 110. In one embodiment, an implementation of the density logic 206 may be used to determine the node density of the current system 110 based on peak usage of resources of nodes 112a-n included in the current system 110. For example, the density analysis module 122 may determine a combination of constraints on one or more resources (e.g., memory, CPU, or storage) available on each node 112 of the current system 110 using one or more database tables (such as those described in FIG. 3C). In this example, based on the combination of constraints and the amount of resources required to support a given number of VMs during peak usage (retrieved from one or more workload profile(s) 202), the density analysis module 122 may implement density logic 206 to determine the node density of the current system 110. In various embodiments, the node density of the current system 110 is determined periodically and stored in the historical density information 204. In such embodiments, an implementation of density logic 206 may subsequently determine the node density of the current system 110 based on the greatest node density recorded in the historical density information 204 for the nodes 112a-n included in the current system 110 during a specified time period.

The density logic 206 may also include logic to determine the node density associated with the current system 110 based on possible migrations of infrastructure. For example, the node density of the current system 110 may be determined based on the migration of storage from one cluster of the current system 110 to another cluster of the current system 110 in order to rebalance infrastructure between the clusters. This allows the density analysis module 122 to determine the node densities based on the most efficient use of resources in the current system 110.

The node density logic 206 may also be implemented to determine a number of VMs that potentially may be supported by the number of nodes 112a-n of the current system. Note that this number may be different from the number of VMs actually supported by the nodes 112a-n of the current system 110, even during times of peak resource usage. For example, if a node 112 of the current system 110 is being underutilized, the number of VMs actually supported by the node 112 during times of peak resource usage will be fewer than the maximum number of VMs that potentially may be supported by the node 112. The potential or maximum node density associated with the current system 110 may be determined by comparing the amount of resources (e.g., memory, CPU, or storage) required to support a given number of VMs during peak usage (e.g., retrieved from one or more workload profile(s) 202), and the corresponding amount of resources available to the nodes 112a-n of the current system 110 (e.g., retrieved from one or more infrastructure profile(s) 208). Density logic 206 implemented by the density analysis module 122 may then be used to determine whether any additional VMs may be supported on the nodes 112a-n of the current system 110. Based on this determination, the potential or maximum node density associated with the current system 110 may be calculated.

The density logic 206 may be stored in one or more user editable documents (e.g., in the database 130). The density logic 206 may comprise a series of if-then statements. For example, pseudo-code for density logic might dictate that if the workload profile(s) 202 describe one or more VMs supported by the nodes 112a-n of the current system 110, then a number of additional VMs that may be supported by an amount of remaining resources available on the nodes 112a-n should be determined; else, the number of VMs supported by the current system 110 and the number of additional VMs that may be supported by the current system 110 is equal to zero or null (i.e., a current system 110 is not in place).

Density logic 206 also describes various types of logic for determining a projected increase in node density during the analysis period. For example, density logic 206 might first determine if historical density information 204 is available. If so, a machine-learned model 124 is trained to determine the projected increase in node density during the analysis period using the historical density information 204. However, density logic may be far more complex, and may further incorporate various factors, such as an amount of time elapsed since a most recent doubling of a number of transistors in an integrated circuit, recent trends in the average amount of time between doublings of the number of transistors in an integrated circuit, or any other relevant factor for determining the projected increase in node density during the analysis period.

The node density associated with the current system 110 and projected increase in node density during the specified analysis period may be expressed in various ways. For example, if multiple node densities of the current system 110 and/or multiple projected increases in node density are determined (e.g., based on different implementations of density logic 206), the node densities may be expressed as a set of values (e.g., as a range). As an additional example, the projected increase in node density may be expressed as an annual percentage increase, a monthly percentage increase, etc.

Once the density analysis module 122 has determined one or more node densities associated with the current system 110 and one or more projected increases in node density during the specified analysis period, the density analysis module 122 communicates this information to the system planning unit 125. For example, if density logic 206 implemented by the density analysis module 122 determines a number of VMs that potentially may be supported by the number of nodes 112 of the current system 110, this information may be provided as an input to the system planning unit 125. The system planning unit 125 may then use the inputs received from the density analysis module 122, along with one or more infrastructure profile(s) 208 and growth/analysis period inputs 210 described above to determine one or more new configuration(s) 150 for the system. Similar to the inputs to the density analysis module 122, the inputs to the system planning unit 125 may be received or retrieved from multiple sources (e.g., a system administrator, the database 130, etc.). While these inputs are not all required, the received inputs provide the information that may be used to determine a new configuration 150 of the system.

The system planning unit 125 may retrieve one or more infrastructure profile(s) 208 describing various characteristics of nodes that potentially may be included in a new configuration 150 as new nodes 162a-n to support a given number of VMs during the analysis period. For example, to determine the number and types of new nodes 162a-n that may be included in a new configuration 150, the system planning unit 125 retrieves one or more infrastructure profiles 208 (e.g., such as those shown in FIGS. 3A-3C) describing the infrastructure of types of nodes that may be included in the new system 160 (e.g., memory, CPU, storage capacities, etc.). In various embodiments, the infrastructure profile(s) 208 and/or the growth/analysis period inputs 210 may be passed to the system planning unit 125 from the density analysis module 122.

In some embodiments, the system planning unit 125 also determines the new configuration(s) 150 based at least in part on one or more planning restrictions 212 that describe restrictions or rules to which the new configuration(s) 150 must comply. The planning restriction(s) 212 may be applied to one or more inputs of the system planning unit 125 (e.g., the infrastructure profile(s) 208 and growth/analysis period inputs 210). Planning restriction(s) 212 can be inclusive, or exclusive, and include Boolean filters, price filters, brand preferences, space requirements, power usage requirements, network capabilities, software capabilities, numerical filters that select for inclusion or exclusion using one or more calculations, or any other relevant factor for determining an optimal or preferred new configuration 150. Furthermore, planning restriction(s) 212 can include any combination of appropriate filters, filtering techniques, preferences, requirements, etc. Planning restriction(s) 212 can provide blanket exclusions of one or more infrastructure types. For instance, one planning restriction 212 may select for nodes that include at least a minimum storage capacity or exclude devices that do not include at least the minimum storage capacity.

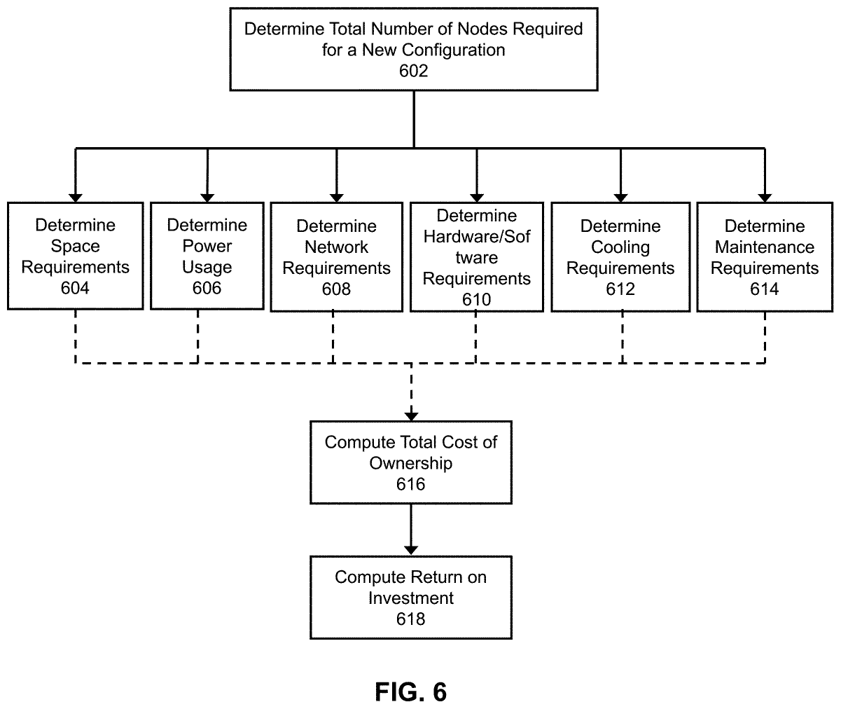

The system planning unit 125 may use one or more planning algorithm(s) 126 to determine a new configuration 150 of the system. One or more node densities associated with the current system 110, one or more projected increases in node density determined by the density analysis module 122, one or more infrastructure profile(s) 208, growth/analysis period inputs 210, and one or more planning restriction(s) 212 may serve as inputs to the planning algorithm(s) 126. For example, a particular planning algorithm 126 may determine a number of a specific type of node (specified in a planning restriction 212) to be included in a new configuration 150 of the system by performing various mathematical calculations on various inputs received by the system planning unit 125. Here, the inputs may include the number of nodes 112a-n included in the current system 110 (retrieved from the infrastructure profile(s) 208), the node density of the current system 110, the projected increase in node density, a number of VMs that potentially may be supported by the number of nodes 112a-n of the current system 110 (received as inputs from the density analysis module 122), the number of VMs expected to be required by the end of the analysis period, and the analysis period (received as growth/analysis period inputs 210). In some embodiments, in addition to determining one or more potential new configuration(s) 150 of the system, the system planning unit 125 also uses one or more planning algorithms 126 to determine various resource requirements (e.g., rack space and cooling requirements) and costs associated with each possible configuration (e.g., ROI and TCO), as further described below in conjunction with FIG. 6.

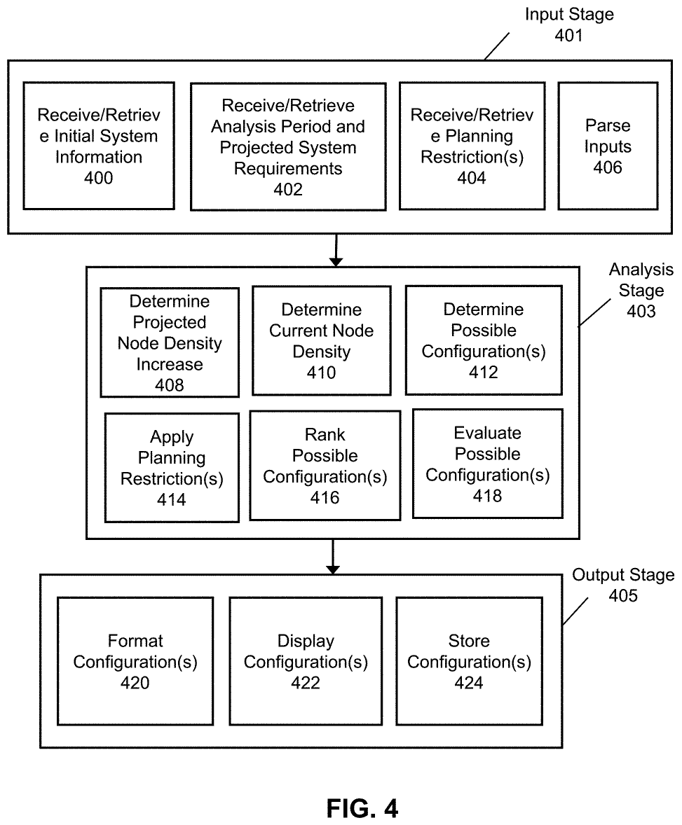

In some embodiments, multiple new configurations 150 of the system may be determined by the system planning unit 125. For instance, a new configuration 150 of the system that supports 200 virtual desktop interface users may comprise a first result recommending 25 units of a particular type of node having both high CPU and high storage capabilities, which occupies a small amount of space, but has a high price tag. In addition, another new configuration 150 may recommend 60 units of a different type of node having moderate CPU and moderate storage capabilities, which occupies a moderate to large amount of space, but has a low price tag. Under some circumstances, such open-ended new configuration 150 recommendations may create an unmanageable number of recommendations. Therefore, potential new configurations 150 may be further refined using integration of additional parameters or ranking of results using price, or any other appropriate factors. Details of ranking and evaluating new configurations 150 are further discussed below in conjunction with FIG. 4.

As discussed above in regard to FIG. 1, the system planner 120 may operate remotely. However, the system planner 120 may also operate across one or more systems. For instance, the density analysis module 122 and the system planning unit 125 could operate on different systems. Furthermore, multiple instances of a given system planner 120 may be executed in parallel using multiple systems, such as in a cluster environment wherein a plurality of nodes on a cluster may execute a version of the system planner 120 against one or more dissimilar sets of inputs or using one or more dissimilar algorithms or some combination thereof

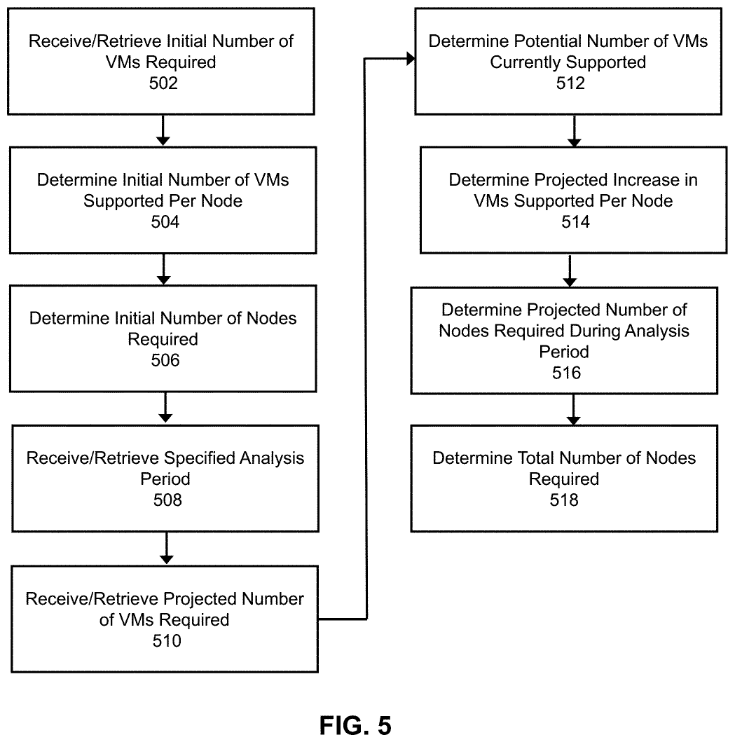

FIGS. 4 and 5 illustrate flowcharts of the operation of the system planner 120 in accordance with some embodiments. Referring first to FIG. 4, the system planner 120 determines new configuration(s) 150 of the system in three stages comprising an input stage 401, an analysis stage 403, and an output stage 405. Each of the stages, in turn, comprise various steps, some of which are optional in different embodiments. Each of these steps may comprise one or more sub-steps. In some embodiments, the steps of various stages and their sub-steps may be performed in an order different from that described in FIG. 4.

The input stage 401 may include the steps of receiving/retrieving 400 initial system information about a current system 110, receiving/retrieving 402 analysis period and projected system requirements of the current system 110, and receiving/retrieving 404 planning restrictions for the new configuration(s) 150 of the system. In embodiments in which a current system 110 is not in place, the information received at step 400 may indicate this (e.g., the information received has a value of null). Alternatively, the absence of a current system 110 may be indicated by the absence of step 400 from the input stage 401. As described above in conjunction with FIG. 2, the analysis period and projected system requirements of the current system 110 received/retrieved at step 402 may include information such as a time period (e.g., a number of months or years from a present time) during which the number of virtual machines required to be supported by the system is expected to grow and a number of virtual machines expected to be required by the end of the analysis period, respectively. The planning restrictions that may be received in step 404 may include restrictions or rules to which the new configuration(s) 150 must comply (e.g., space and cost constraints to which new nodes 162a-n of any new configuration 150 must not exceed). Like step 400, in embodiments in which planning restrictions are not available or provided, the information received at step 404 may indicate this or step 404 may be absent altogether from the input stage 401.

These inputs may optionally be parsed at 406, to verify the syntax of the inputs received/retrieved during the other steps of the input stage 401 prior to further processing. Verification of the syntax is performed to verify that the parameters enumerated in the inputs correspond at least to the required inputs for the system planner 120 during the analysis stage 403. Further verification can be performed to verify optional inputs and verifying whether there are any additional inputs that do not correspond to expected inputs for the system planner 120. The system planner 120 may generate a notification in response to detecting any verification issues. Syntax errors, for example, may trigger warnings or error messages, or other notification mechanisms, as appropriate. These warnings or error messages may then be communicated to the administrator (e.g., via a management console 140). The administrator may choose to ignore one or more errors and proceed with the analysis stage at 403, regardless of the presence of errors or warnings.

Each of the steps of the input stage 401, in turn, may comprise multiple sub-steps at varying levels of granularity. For example, the step of receiving/retrieving 400 initial system information about a current system 110 may comprise receiving one or more workload profile(s) 202, historical density information 204, and one or more infrastructure profile(s) 208, each of which may be received separately or in multiple transactions. As an additional example, the step of receiving/retrieving 402 analysis period and projected system requirements of the current system 110 may correspond to sub-steps comprising receiving/retrieving a specified analysis period and receiving/retrieving a projected number of virtual machines required at the end of the specified analysis period. Furthermore, each of the steps of the input stage 401 may involve sub-steps that include both the retrieval as well as the receipt of information by the system planner 120. For example, the system planner may retrieve 404 a set of planning restrictions based on an organization's policies and may receive 404 additional planning restrictions provided as inputs from a system administrator.

Once the input stage 401 is complete, the system planner 120 may move on to the analysis stage 403. The analysis stage 403 may comprise the step of determining 408 the projected increase in node density, as described above in conjunction with the functionality of the density analysis module 122 in FIGS. 1 and 2. In some embodiments, the system planner 120 is not required to determine 408 the projected increase in node density. For example, a system administrator may provide a projected increase in node density to use in subsequent steps of the analysis stage 403 (e.g., based on Moore's Law or any other suitable theory/observation). In such embodiments, step 408 may be absent from the analysis stage 403. In embodiments in which a current system 110 is in place, the analysis stage 403 may also include the step of determining 410 the node density of the current system 110, which is also described above in conjunction with the functionality of the density analysis module 122 in FIGS. 1 and 2. However, in embodiments in which a current system 110 is not in place, step 410 may be absent from the analysis stage 403.

The analysis stage 403 also includes the step of determining 412 one or more possible new configuration(s) 150 of the system that will support the anticipated system requirements during the analysis period. Here, the system planner 120 executes the computations/logic in the planning algorithms 126 of the system planning unit 125. For instance, execution may include selecting all possible new configurations 150 that would meet anticipated increases in resource requirements during the specified analysis period by determining the number and type of node(s) having the required features capable of doing so. Such possible new configurations 150 may include a single new configuration 150, or any number of new configurations 150, as dictated by the received/retrieved inputs of the input stage 401.

Step 412 may correspond to various combinations of sub-steps. For example, to determine 412 one or more possible new configuration(s) 150 of the system, the system planner 120 may first determine the initial number of nodes required by the current system 110 and the number of nodes required during the analysis period to determine a total number of nodes to include in each of the possible new configuration(s) 150. Determining the number of nodes required during the analysis period may further comprise the sub-steps of determining the potential number of virtual machines supported by the current system 110 and implementing a planning algorithm 126 to determine the number of nodes required during the analysis period based at least in part on the potential number of virtual machines supported by the current system 110. As described above in conjunction with FIGS. 1 and 2, the possible new configuration(s) 150 may also be determined 412 based on additional inputs, such as infrastructure profile(s) 208 of nodes that may be included in a new configuration 150.

In various embodiments, the analysis stage 403 may also include additional optional steps. For example, in embodiments in which the input stage 401 includes the step of receiving/retrieving 404 one or more planning restriction(s) 212, the analysis stage 403 may include the step of applying 414 the one or more planning restriction(s) 212 to the possible configuration(s) determined in step 412. For example, if a planning restriction 212 specifies that a particular type of node should not be included in the new system 160, any new configuration(s) 150 including the type of node may be removed from the possible new configuration(s) 150 when applying 414 the planning restriction(s) 212. In some embodiments, the step of applying 414 the planning restriction(s) 212 may be integrated into step 412, such that the possible new configuration(s) 150 include only those configurations that comply with the planning restriction(s) 212.

The system planner 120 may alternatively rank 416 possible new configuration(s) 150, such that any possible new configuration(s) 150 that violate one or more planning restriction(s) 212 may be ranked lower than those that do not. The system planner 120 may also rank 416 the possible new configuration(s) 150 based on other factors, such as an expected total cost of the new configuration(s) 150, an expected amount of power consumption required by the new configuration(s) 150, or any other suitable factor. Ranking 416 may include applying numerical rankings, if-then selection rankings, or any other forms of rankings, as determined by the system planner 120. For instance, rankings can include a selection or a numerical ranking of various possible new configuration(s) 150. Rankings may be applied to specific characteristics of possible new configuration(s) 150. For example, rankings may be based on storage capacities of nodes included in each possible new configuration 150.

The step of evaluating 418 the possible new configuration(s) 150 may comprise allowing a system administrator or other user to evaluate 418 the possible new configuration(s). For example, the system planner 120 may present the possible new configuration(s) 150 in a graphical user interface, allowing a user to provide an input (e.g., via a management console 140) to further narrow the possible new configuration(s) 150 by eliminating various possible new configuration(s) 150. A system administrator or other user may evaluate 418 each possible new configuration 150 individually or as a whole. For example, a graphical user interface may present graphs or charts that allow a user to perform side-by-side comparisons of multiple new configurations 150 (e.g., based on node types, number of nodes, total resource capacity, etc.) and also allow the user to select and further inspect an individual new configuration 150.

Note that the steps of the analysis stage 403 may be performed in a different order than just described and may also be performed any number of times. For example, the system planner 120 may rank 416 multiple possible configurations and identify a specified number of top ranked configurations (e.g., based on cost). The system planner 120 may then apply 414 planning restriction(s) 212 to the possible new configuration(s) 150 and then rank 416 the possible new configuration(s) 150 again, with the configuration(s) that violate the planning restriction(s) 212 ranked lower than those that do not.

The output stage 405, may include the steps of formatting 420 the new configuration(s) 150, displaying 422 the new configuration(s) 150, and storing 424 the new configuration(s) 150 or some combination thereof. The new configuration(s) 150 may be formatted 420 for display or production, such as for printing, as web content, as content for a custom management console, in word documents, PDFs, spreadsheets, presentations, or any other display or data content. The new configuration(s) 150 may be displayed 422 to a system administrator or other user, such as on a management console 140 or via a print out or electronic document. The new configuration(s) may also or alternatively be stored 424 for later review (e.g., as a new system output 134) in database 130.

FIG. 5 illustrates an alternative flowchart of the operation of the system planner 120. Generally, the system planner 120 determines the total number of nodes required in the new system 160 by first determining an initial number of nodes required (i.e., the number of nodes 112a-n included in the current system 110), determining a number of nodes required during the analysis period, and determining the total number of nodes required in the new system 160 as a sum of the initial number of nodes required and the number of nodes required during the analysis period. In some embodiments, the steps may be performed in an order different from that described in FIG. 5.

In the first step of the process illustrated in FIG. 5, the system planner 120 receives/retrieves 502 information describing an initial number of VMs required to be supported by a current system 110 (i.e., an initial number of VMs required to support a current workload), assuming a current system 110 is in place. The initial number of VMs required may be retrieved 502 from one or more workload profile(s) 202 or received 502 as an input from a user (e.g., via a management console 140). For example, the initial number of VMs required may be based on historical information retrieved from one or more workload profile(s) 202 describing a peak number of VMs required by the current system 110 (e.g., during the previous 6 months).

Once the initial number of VMs required has been received/retrieved 502, the system planner 120 may determine 504 the initial number of VMs supported per node. The system planner 120 may make this determination based on the initial number of VMs required and information retrieved from one or more workload profile(s) 202. For example, workload profile(s) 202 may describe an amount of memory, CPU, or storage required by one or more nodes 112a-n of the current system 110 to support a given number of virtual machines. Here, the system planner 120 may determine 504 the initial number of VMs supported per node based on peak usage of resources of nodes 112a-n included in the current system 110. Alternatively, the node density of the current system 110 may be based on the greatest node density recorded in the historical density information 204 for the nodes 112a-n included in the current system 110 during a specified time period.

The system planner 120 may next determine 506 the initial number of nodes required based on the initial number of VMs required and the initial number of VMs supported per node. For example, the initial number of VMs required may be divided by the initial number of VMs supported per node to determine 506 the initial number of nodes required. Here, the initial number of nodes required may be rounded up, such that the initial number of nodes required is a whole number. If a current system 110 is in place, rather than assuming the initial number of nodes required is simply equal to the number of nodes 112a-n in the current system 110, the system planner 120 may be required to first perform steps 502 and 504 before determining 506 the initial number of nodes required. This is because in some situations, a number of nodes may have been previously purchased that are in excess of the initial number of nodes actually required. For example, an organization that has 8 nodes 112a-h in their current system 110 may only need to utilize 7 of the nodes 112a-g if the workloads across the nodes 112a-h are more efficiently consolidated. Therefore, rather than assuming that all nodes 112a-n of the current system 110 are required, the system planner 120 determines 506 the initial number of nodes required based on the initial number of VMs required and the initial number of VMs supported per node.

In embodiments in which a current system 110 is not in place, the steps just discussed in FIG. 5 may be absent. The next set of steps illustrated in FIG. 5 describe how the system planner 120 may determine a number of nodes required during the analysis period. These steps may be present in various embodiments regardless of whether or not a current system 110 is in place.

Determining the number of nodes required during the analysis period may begin with the system planner 120 receiving/retrieving 508 information describing a specified analysis period. The analysis period may span any amount of time that extends from a present time to a time in the future. The analysis period may be expressed in various ways. For example, if the current year is 2016, an analysis period that ends in 2020 may be expressed as the year that the analysis period ends (i.e., 2020), as a number of years from the present (i.e., 4 years), or as a time span (i.e., 2016-2020). The analysis period may also be expressed at various levels of granularity. As an example, the analysis period may be expressed in units of years, months, days, or any other unit of time.

In the next step of the process, the system planner 120 may receive/retrieve 510 a projected number of VMs required during the analysis period. The projected number of VMs required may be received 510 (e.g., as an input from a user via the management console 140). Alternatively, the projected number of VMs required may be retrieved 510 by the system planner 120. For example, if the machine-learning module 123 of the density analysis module 112 trains a machine-learned model 124 to predict a number of virtual machines expected to be required at the end of the analysis period, the prediction may be stored in the database 130 (e.g., as a planning input 132) and later retrieved 510 by the planning module 120.

In embodiments in which a current system 110 is in place, the system planner 120 may next determine 512 a potential number of VMs currently supported. This determination may be made by the density analysis module 122 of the system planner 120 via an implementation of node density logic 206. For example, based on the initial number of VMs supported per node 112 and a number of computing resources, storage resources, and other types of resources remaining on nodes 112a-n of the current system 110, the node density logic 206 may extrapolate a number of additional VMs that may be supported per node 112. The system planner 120 may then determine 512 the potential number of VMs currently supported as a sum of the initial number of VMs supported per node 112 and the extrapolated number of additional VMs that may be supported per node 112. Note that the potential number of VMs currently supported may or may not be the same as the initial number of VMs supported per node 112 determined in step 504. The reason for this is that the potential number of VMs currently supported may be greater than the initial number of VMs supported per node 112. For example, the nodes 112a-n of the current system 110 may be underutilized, such that the nodes 112a-n may support additional VMs in addition to the initial number of VMs supported per node 112.

The next step of the process continues with the system planner 120 determining 514 the projected increase in node density during the specified analysis period. As described above, this determination may be made by the density analysis module 122 of the system planner 120, which may make the determination for various types of nodes having different characteristics. For example, the density analysis module 122 may include a machine-learning module 123 that trains one or more machine-learned models 124, which may be used to determine the projected increase in node density for various series 305 and models 310 of nodes during the specified analysis period. In some embodiments, the density analysis module 122 may receive explicit information describing the projected increase in node density (e.g., from a system administrator or retrieved from the database 130). In such embodiments, the system planner 120 may skip step 514 and instead move onto the next step of the process using the explicit information describing the projected increase in node density that was received.

The system planner 120 may use the specified analysis period, the projected number of VMs required during the analysis period, the potential number of VMs currently supported, and the projected increase in VMs supported per node to determine 516 a projected number of nodes required during the analysis period. For example, the system planning unit 125 of the system planner 120 may use a planning algorithm 126 that first subtracts the potential number of VMs currently supported from the projected number of VMs required during the analysis period. The planning algorithm 126 may then divide this difference by the number of VMs supported per node during each year of the analysis period. Finally, the planning algorithm 126 may perform a summation of this quotient over the number of years of the analysis period to determine 516 the projected number of nodes required during the analysis period. The planning algorithm 126 may further round up the result of the summation so that the projected number of nodes required during the analysis period is a whole number. In embodiments in which a current system 110 is not in place, the planning algorithm 126 may set the potential number of VMs currently supported to 0. Alternatively, the system planning unit 125 may use a different planning algorithm 126 to determine 516 the projected number of nodes required during the analysis period. For example, the planning algorithm 126 may skip the step of first subtracting the potential number of VMs currently supported from the projected number of VMs required during the analysis period.

The system planner 120 may then determine 518 the total number of nodes required at the end of the analysis period (i.e., the total number of nodes included in a new configuration 150 of the system). The total number of nodes required at the end of the analysis period may be determined 518 by the system planner 120 for one or more specific types of nodes (e.g., nodes of a specific series 305, model 310, server compute 315, storage capacity 320, etc., as described in FIGS. 3A-3C). In embodiments in which a current system 110 is in place, the total number of nodes required at the end of the analysis period may be determined as a sum of the initial number of nodes required and the projected number of nodes required during the analysis period. In embodiments in which a current system 110 is not in place, the total number of nodes required at the end of the analysis period is simply equal to the projected number of nodes required during the analysis period.

FIG. 6 illustrates a method for determining resource requirements associated with a new configuration 150 of the system. The resource requirements depicted are those that are likely to be considered by a system administrator or other user when evaluating 416 one or more possible new configuration(s) 150 of the system. It should be noted that the resource requirements are only intended as examples, and are not intended as an exhaustive description of the types of resource requirements that may be determined for each possible new configuration 105 of the system.

The resource requirements may be determined once the total number of nodes required for a new configuration 150 has been determined 602. In one embodiment, the system planning unit 125 of the system planner 120 may include one or more planning algorithm(s) 126 that may be used to determine the resource requirements for each possible new configuration 150. The resource requirements may include space requirements 604, power usage 606, network requirements 608, hardware/software requirements 610, cooling requirements 612, and maintenance requirements 614 of the possible new configuration(s) 150. In one embodiment, each of the resource requirements may be determined by multiplying the total number of nodes required at the end of the analysis period by a factor associated with each type of resource requirement. For example, if each new node 162 of a new configuration 150 takes up 1/8 of a rack, the total number of nodes required at the end of the analysis period may be multiplied by 1/8 to determine 604 the space requirements for the nodes in terms of the total number of racks required to house the nodes. Similarly, the power usage may be determined 606 by multiplying the total number of nodes required at the end of the analysis period by the number of kilo-watt hours required to power a single node, while the maintenance requirements may be determined 614 by multiplying the total number of nodes required at the end of the analysis period by the amount of planned and estimated unplanned maintenance required for a single node, etc.

Each of the resource requirements may be determined separately for different types of nodes. For example, if the current system 110 includes a particular type of node (e.g., nodes of a particular series 305 or model 310) and new nodes 162a-n of a new configuration 150 are of a different type, the power usage and cooling requirements of the types of nodes may also be different. Here, the power usage may be determined 606 separately for each type of node and subsequently summed; a similar approach may be used to determine 612 the cooling requirements or any other suitable resource requirements.

The system planning unit 125 may also include various planning algorithms 126 that may be used to determine a cost associated with each of the resource requirements associated with the total number of nodes required for a new configuration 150. For example, the system planning unit 125 may use an algorithm to determine 604 a cost associated with the space requirements of the total number of nodes required for a new configuration 150 (e.g., cost of rack space, cost of office space to house the racks, etc.). Furthermore, the system planning unit 125 may also include various planning algorithms 126 that may use the cost aspect associated with each of the resource requirements to determine one or more cost-related values associated with the total number of nodes required to implement a particular new configuration 150. For example, a planning algorithm 126 may be used to compute 616 the total cost of ownership if a particular new configuration 150 is implemented by summing the cost aspect associated with each of the resource requirements determined for the total number of nodes required. As an additional example, a planning algorithm may be used to compute 618 the return on investment of the new configuration in the previous example by subtracting the total cost of ownership from an estimated financial gain resulting from investment in the total number of nodes required and then dividing the difference by the total cost of ownership.

In the context of FIG. 4, the resource requirements, as well as any cost-related values determined 604-618 for each possible new configuration 150 may be used in various steps of the analysis stage 403. For example, planning restrictions 212 may be applied to each possible new configuration 150 based on the cost associated with maintenance requirements for each configuration 150. As an additional example, the return on investment determined 618 for each possible new configuration 150 may be used to rank 416 or evaluate 418 the new configurations 150.

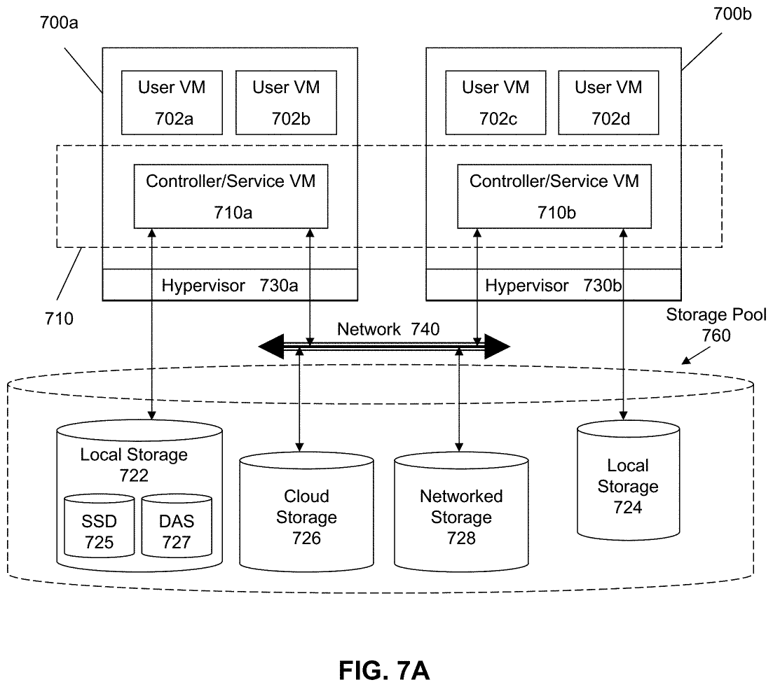

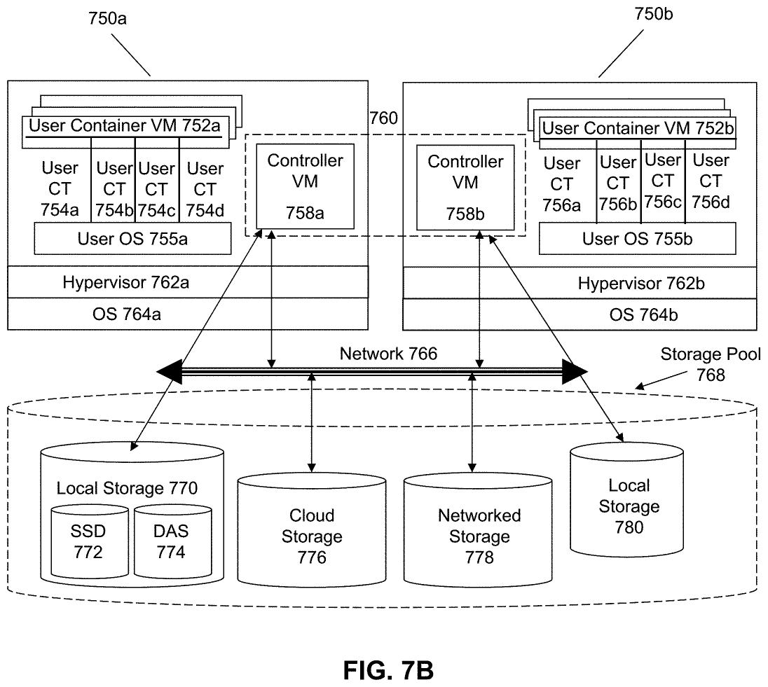

FIG. 7A illustrates a clustered virtualization environment in which some embodiments are implemented. The sizing system may operate in a clustered virtualization environment, such as via a management console or on within the cluster itself. Further, information for and about the cluster may be used as inputs to the sizing unit such that the cluster can be used to size either itself or another cluster.

The architecture of FIG. 7A can be implemented for a distributed platform that contains multiple servers 700a and 700b that manages multiple-tiers of storage. The multiple tiers of storage may include storage that is accessible through a network 740, such as cloud storage 726 or networked storage 728 (e.g., a SAN or “storage area network”). Unlike the prior art, the present embodiment also permits local storage 722/724 that is within or directly attached to the server and/or appliance to be managed as part of the storage pool 760. Examples of such storage include Solid State Drives (henceforth “SSDs”) 725 or Hard Disk Drives (henceforth “HDDs” or “spindle drives”) 727. These collected storage devices, both local and networked, form a storage pool 760. Virtual disks (or “vDisks”) can be structured from the storage devices in the storage pool 760, as described in more detail below. As used herein, the term vDisk refers to the storage abstraction that is exposed by a Controller/Service VM to be used by a user VM. In some embodiments, the vDisk is exposed via iSCSI (“internet small computer system interface”) or NFS (“network file system”) and is mounted as a virtual disk on the user VM.

Each server 700a or 700b runs virtualization software, such as VMware ESX(i), Microsoft Hyper-V, or RedHat KVM. The virtualization software includes a hypervisor 730a/730b to manage the interactions between the underlying hardware and the one or more user VMs 702a, 702b, 702c, and 702d that run client software.

A special VM 710a/710b is used to manage storage and I/O activities according to some embodiment of the invention, which is referred to herein as a “Controller/Service VM”. This is the “Storage Controller” in the currently described architecture. Multiple such storage controllers coordinate within a cluster to form a single-system. The Controller/Service VMs 710a/710b are not formed as part of specific implementations of hypervisors 730a/730b. Instead, the Controller/Service VMs run as virtual machines above hypervisors 730a/730b on the various servers 702a and 702b, and work together to form a distributed system 710 that manages all the storage resources, including the locally attached storage 722/724, the networked storage 728, and the cloud storage 726. Since the Controller/Service VMs run above the hypervisors 730a/730b, this means that the current approach can be used and implemented within any virtual machine architecture, since the Controller/Service VMs of embodiments of the invention can be used in conjunction with any hypervisor from any virtualization vendor.

Each Controller/Service VM 710a-b exports one or more block devices or NFS server targets that appear as disks to the client VMs 702a-d. These disks are virtual, since they are implemented by the software running inside the Controller/Service VMs 710a-b. Thus, to the user VMs 702a-d, the Controller/Service VMs 710a-b appear to be exporting a clustered storage appliance that contains some disks. All user data (including the operating system) in the client VMs 702a-d resides on these virtual disks.

Significant performance advantages can be gained by allowing the virtualization system to access and utilize local (e.g., server-internal) storage 722 as disclosed herein. This is because I/O performance is typically much faster when performing access to local storage 722 as compared to performing access to networked storage 728 across a network 740. This faster performance for locally attached storage 722 can be increased even further by using certain types of optimized local storage devices, such as SSDs 725. Further details regarding methods and mechanisms for implementing the virtualization environment illustrated in FIG. 7A are described in U.S. Pat. No. 8,601,473, which is hereby incorporated by reference in its entirety.

FIG. 7B illustrates an alternative approach for virtualized computing environments using containers. Generally, containers are a type of operating-system level application virtualization, in which the containers run applications in individual execution environments that are isolated from the host operating system and from each other. Some existing systems for running containerized applications include Linux LXC and Docker.

Containers running applications (e.g., containerized applications) have the benefit of being very fast to get up and running because no guest operating system must be installed for the application. The container may interface with the host computer or computers on a network through one or more virtualized network connections, which is managed by a container manager. For example, a web-server container may run web-server application which is addressed by a IP addressed assigned to the container. To address or access the web-server container, a user or computer may use the IP address, which is intercepted by a container manager and routed to the container. Because the container is isolated from the host operating system, such as if the container application is compromised (e.g., hacked), the malicious entity doing the hacking will be trapped inside the container. However, to increase security, a containerized system may be implemented within a virtual machine. In this way, containerized applications can be quickly run modified/updated within the container execution environment, and if one or more of the containers is breached, it will not affect the physical host computer because the container execution environment is still behind a virtual machine.

In FIG. 7B, an approach is illustrated for running containers within a distributed storage system, such as the system of 7A. Though FIG. 7b illustrates a particular architecture involving a controller virtual machine and user virtual machine which has user containers, one of ordinary skill in the art appreciates that other configurations may be implemented as well. Other approaches, and configurations are discussed in U.S. application No. 62/171,990, filed on Jun. 5, 2015, which is hereby incorporated by reference in its entirety.

In FIG. 7B, a distributed platform contains multiple servers 750a and 750b that manage multiple-tiers of storage. In some embodiments, the servers 750a and 750b are physical machines with hardware layer such as memory or processors (not depicted) upon which an operating system may be installed. The managed multiple tiers of storage include storage that is accessible through a network 766, such as cloud storage 776 or networked storage 778 (e.g., a SAN or “storage area network”). Additionally, the present embodiment also permits local storage 770 and/or 780 that is within or directly attached to the server and/or appliance to be managed as part of the storage pool 768. Examples of such storage include Solid State Drives (henceforth “SSDs”) 772 or Hard Disk Drives (henceforth “HDDs” or “spindle drives”) 780 or other types of local storage directly that is directly attached (e.g., direct attached storage, DAS 774). These collected storage devices, both local and networked, form a storage pool 768.

Virtual disks (or “vDisks”) can be structured from the storage devices in the storage pool 768, as described in more detail below. As used herein, the term vDisk refers to the storage abstraction that is exposed by a controller/service VM to be used by a user VM or a user container (CT). In some embodiments, the vDisk is exposed via iSCSI (“internet small computer system interface”) or NFS (“network file system”) and is mounted as a virtual disk on the user VM.

Each server 750a or 750b runs virtualization software, such as VMware ESX(i), Microsoft Hyper-V, or RedHat KVM. The virtualization software includes a hypervisor 762a-b to manage the interactions between the underlying hardware and the one or more user CTs that run client software, such as containerized applications.

The servers 750a-b may implement virtual machines with an operating system 764a-b that supports containers (e.g., Linux) and VM software, such as hypervisors 762a-b. In particular, as illustrated in FIG. 7a for example, node or server 750a runs a controller VM 758a and a user container VM 752a that runs one or more containers 754a-d from a user OS 755a. Each of the user containers may run a container image that may be layered to appear as a single file-system for that container. For example, a base layer may correspond to a Linux Ubuntu image, with an application execution layer on top; the application execution layer corresponding to a read/write execution environment for applications, such as MySQL, webservers, databases or other applications.

In some embodiments, the controller virtual machines 758a-b are used to manage storage and I/O activities for the user containers 754a-d. The controller virtualized computer is the “Storage Controller” in the currently described architecture. Multiple such storage controllers coordinate within a cluster to form a single-system. The Controller VMs 758a-b are not formed as part of specific implementations of respective hypervisors 762a-b. Instead, each controller VM runs as a virtual machine above its respective hypervisors 762a-b on the various servers 750a and 750b, and work together to form a distributed system 760 that manages all the storage resources, including the locally attached storage 770/780 the networked storage 778, and the cloud storage 776.

Each controller VM 758a-b exports one or more block devices or NFS server targets that appear as disks to the user container VM 752a-b. These disks are virtual, since they are implemented by the software running inside the controller VMs 758a-b. Thus, to the User-Container VMs 752a-b, the controller VMs 758a-b appear to be exporting a clustered storage appliance that contains some disks. All user data (including the operating system) in the user-container VMs 752a-b resides on these virtual disks. The containers run from within respective user container VMs 752a-b may use the user OSs 755a-b to run isolated containerized directories. Further, each user OS 755a-b may have a container manager installed (e.g., Docker, LXC) to run/manage containers on each respective user container VM 752a-b.

Significant performance advantages can be gained by allowing the virtualization system to access and utilize local (e.g., server-internal) storage 770 as disclosed herein. This is because I/O performance is typically much faster when performing access to local storage 770 as compared to performing access to networked storage 778 across a network 766. This faster performance for locally attached storage 770 can be increased even further by using certain types of optimized local storage devices, such as SSDs 772.

Once the virtualization system is capable of managing and accessing locally attached storage, as is the case with the present embodiment, various optimizations can then be implemented to improve system performance even further. For example, the data to be stored in the various storage devices can be analyzed and categorized to determine which specific device should optimally be used to store the items of data. Data that needs to be accessed much faster or more frequently can be identified for storage in the locally attached storage 770. On the other hand, data that does not require fast access or which is accessed infrequently can be stored in the networked storage devices 778 or in cloud storage 776. Further details regarding an exemplary approach for implementing the virtualization environment are described in U.S. Pat. No. 8,601,473, which is hereby incorporated by reference in its entirety.

In this way, the security and robustness of a distributed storage system using virtual machines (as illustrated in FIG. 7A) may be combined with efficiency and consistency of a container virtualized computer/application environment.

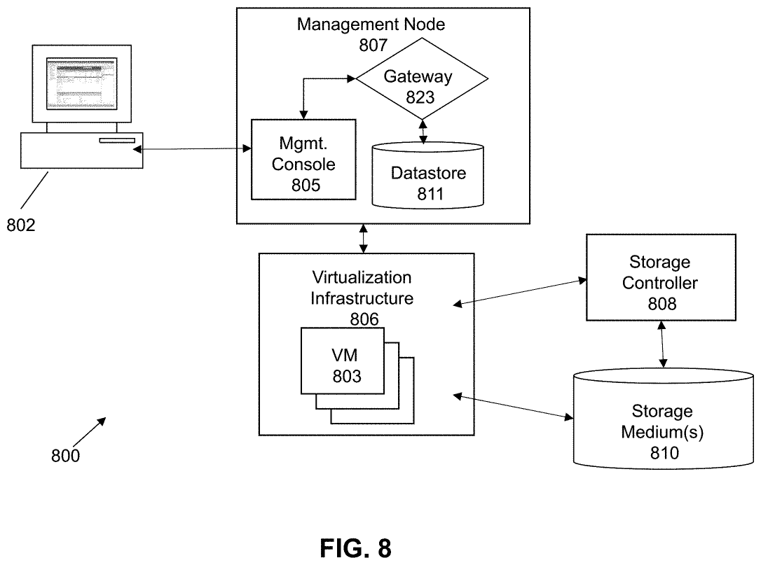

FIG. 8 illustrates a system 800 to implement a virtualization management console 805 according to some embodiments of the invention. In some embodiments, the sizing system may operate in a virtualization management console, such as via a management console or on a cluster itself. Further, information for and about one or more clusters may be used as inputs to the sizing unit such that one or more clusters can be used to size either itself or another cluster.

The system 800 includes one or more users at one or more user stations 802 that use the system 800 to operate the virtualization system 800 and/or management console 805. The user station 802 comprises any type of computing station that may be used to operate or interface with the system 800. Examples of such user stations include, for example, workstations, personal computers, or remote computing terminals. The user station 802 comprises a display device, such as a display monitor, for displaying a user interface to users at the user station. The user station 802 also comprises one or more input devices for the user to provide operational control over the activities of the system 800, such as a mouse or keyboard to manipulate a pointing object in a graphical user interface.

System 800 includes virtualization infrastructure 806, comprising any processing components necessary to implement and provision one or more VMs 803. This may include management components to obtain status for, configure., and/or control the operation of one or more storage controllers and/or storage mediums 810. Data for the VMs 803 are stored in a tangible computer readable storage device 810. The computer readable storage device 810 comprises any combination of hardware and software that allows for ready access to the data that is located at the computer readable storage device 810. The storage controller 808 is used to manage the access and operation of the computer readable storage device 810. While the storage controller is shown as a separate component here, it is noted that any suitable storage controller configuration may be employed. For example, in some embodiments, the storage controller can be implemented as a virtual machine as described in more detail below. As noted in more detail below, the virtualization infrastructure 806 may correspond to a cluster of multiple nodes that are integrated as a single system.

System 800 includes a management console 805. The management console 805 provides an interface that permits an administrator to manage and administer the operation of the system. According to some embodiments, the management console 805 comprises a javascript program that is executed to display a management user interface within a web browser at the user station 802. In some embodiments, the storage controller exposes an API or GUI to create, read, update, delete (CRUD) data stores at the computer readable medium 810, which can be managed by the management console 805.

In operation in some embodiments, a web browser at the user station 802 is used to display a web-based user interface for the management console. The management console 805 corresponds to javascript code to implement the user interface. Metadata regarding the system 800 is maintained at a data store 811, which collects data relating to the virtualization infrastructure 806, the storage mediums 810, and/or datastores at the storage mediums. The javascript code interacts with a gateway 823 to obtain the metadata to be displayed in the user interface. In some embodiments, the gateway comprises a web server and servlet container, e.g., implemented using Apache Tomcat. Further details regarding methods and mechanisms for implementing virtualization management console illustrated in FIG. 8 are described in U.S. Provisional Patent Application No. 62/108,515, which is hereby incorporated by reference in its entirety.

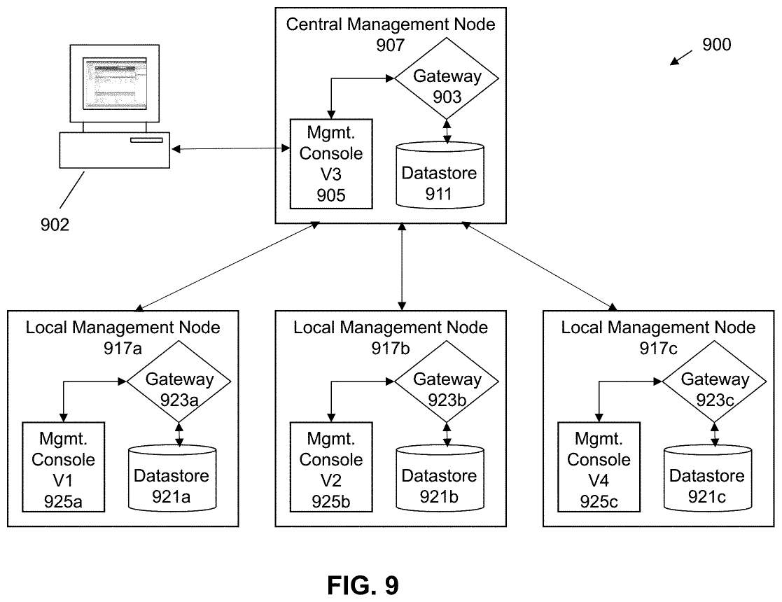

FIG. 9 illustrates a larger computing environment having multiple underlying systems/clusters that need to be managed, where a separate management node exists for each of the underlying systems/clusters.

The sizing system may reside on a Central Management Node for one or more clusters that includes its own management console javascript code 905, for gateway 903, and datastore 911. Shown here are management nodes 917a, 917b, and 917c. Each of these management nodes includes its own management console javascript code 925a-c, gateways 923a-c, and datastore 921a-c. Further, information for and about one or more clusters may be used as inputs to the sizing unit such that one or more clusters can be used to size either itself or another cluster, or all clusters may be sized as a whole or separately with the potential of sharing or migrating infrastructure from one node to another node. Further details regarding methods and mechanisms for implementing virtualization management console illustrated in FIG. 9 are described in U.S. Provisional Patent Application No. 62/108,515, which is hereby incorporated by reference in its entirety.

### System Architecture

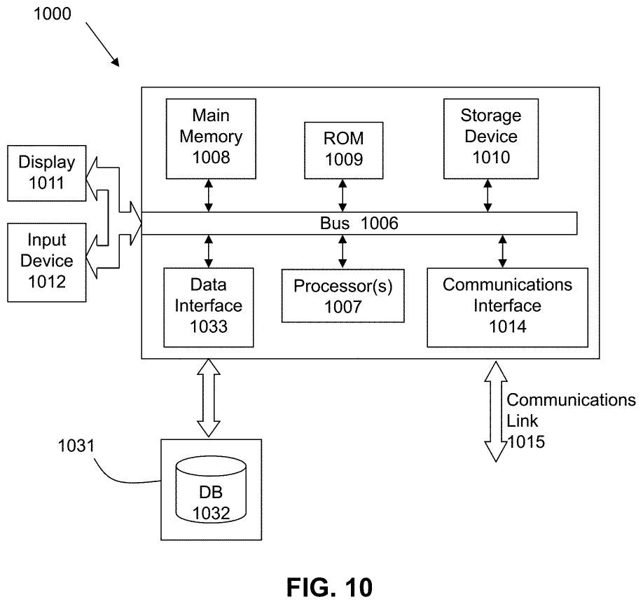

FIG. 10 is a block diagram of an illustrative computing system 1000 suitable for implementing an embodiment of the present invention. Computer system 1000 includes a bus 1006 or other communication mechanism for communicating information, which interconnects subsystems and devices, such as processor 1007, system memory 1008 (e.g., RAM), static storage device 1009 (e.g., ROM), disk drive 1010 (e.g., magnetic or optical), communication interface 1014 (e.g., modem or Ethernet card), display 1011 (e.g., CRT or LCD), input device 1012 (e.g., keyboard), and cursor control.

According to some embodiments of the invention, computer system 1000 performs specific operations by processor 1007 executing one or more sequences of one or more instructions contained in system memory 1008. Such instructions may be read into system memory 1008 from another computer readable/usable medium, such as static storage device 1009 or disk drive 1010. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1007 for execution. Such a medium may take many forms, including but not limited to, non-volatile media and volatile media. Non-volatile media includes, for example, optical or magnetic disks, such as disk drive 1010. Volatile media includes dynamic memory, such as system memory 1008.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1000. According to other embodiments of the invention, two or more computer systems 1000 coupled by communication link 1010 (e.g., LAN, PTSN, or wireless network) may perform the sequence of instructions required to practice the invention in coordination with one another.

Computer system 1000 may transmit and receive messages, data, and instructions, including program, i.e., application code, through communication link 1015 and communication interface 1014. Received program code may be executed by processor 1007 as it is received, and/or stored in disk drive 1010, or other non-volatile storage for later execution. A database 1032 in a storage medium 1031 may be used to store data accessible by the system 1000.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense. software requirements of the projected number of nodes, cooling requirements of the projected number of nodes, maintenance requirements of the projected number of nodes, and any combination thereof.

What is claimed is:

1. A computer implemented method, comprising:
determining an initial density metric comprising a number of virtual machines supported by nodes for use in a networked virtualization system, the initial density metric being based at least in part on a constraint on a resource available on the nodes;
receiving information describing a projected number of virtual machines to be supported by the networked virtualization system at an end of an analysis period;
determining a projected increase in density of virtual machines supported per node at the end of the analysis period; and
determining a projected number of nodes required at the end of the analysis period based at least in part initial density metric, and the projected increase in density of virtual machines supported per node.

2. The method of claim 1, further comprising determining a total cost of ownership or a return on investment associated with the projected number of nodes required during the analysis period.

3. The method of claim 1, wherein the initial density metric is further based on at least a resource available on nodes described in a database table including (i) a first column that identifies a type of resource, (ii) a second column that identifies a subtype of the type of resource identified by the first column, the subtype corresponding to a constraint on availability of the type of resource identified by the first column, and (iii) a row corresponds to a constraint in the second column and to the availability of the type of resource identified by the first column.

4. The method of claim 1, wherein the initial density metric is based at least in part on a combination of constraints on the resource available on the nodes.

5. The method of claim 1, further comprising determining an initial number of nodes required based at least in part on an initial number of virtual machines required to be supported and the initial density metric.

6. The method of claim 5, further comprising determining a total cost of ownership or a return on investment associated with a total number of nodes required in the networked virtualization system.

7. The method of claim 1, further comprising determining a number of virtual machines currently supported based at least in part on the initial density metric and a current number of nodes.

8. The method of claim 1, wherein the projected number of nodes comprise a number of existing nodes and a number of new nodes.

9. The method of claim 1, wherein the nodes are for a networked virtualization environment and node density comprises numbers of virtual machines supported per node.

10. The method of claim 1, wherein the projected increase in density of virtual machines supported per node is determined using a machine-learning model.

11. The method of claim 10, wherein the machine-learning model is trained using historical information describing a number of virtual machines supported per node included in the networked virtualization system.

12. The method of claim 5, wherein a total number of nodes required in a networked virtualization system is determined subject to two or more restrictions.

13. The method of claim 1, further comprising determining a resource required by a networked virtualization system based at least in part on the projected number of nodes required during the analysis period.

14. The method of claim 13, wherein the resource is selected from a group consisting of: physical space requirements of the projected number of nodes, power usage by the projected number of nodes, network requirements of the projected number of nodes, software requirements of the projected number of nodes, cooling requirements of the projected number of nodes, maintenance requirements of the projected number of nodes, and any combination thereof.

15. A non-transitory computer readable medium having stored thereon a sequence of instructions which, when executed by a processor causes a set of acts, the set of acts comprising:
determining an initial density metric comprising a number of virtual machines supported by nodes for use in a networked virtualization system, the initial density metric being based at least in part on a constraint on a resource available on the nodes;
receiving information describing a projected number of virtual machines to be supported by the networked virtualization system at an end of an analysis period;
determining a projected increase in density of virtual machines supported per node at the end of the analysis period; and
determining a projected number of nodes required at the end of the analysis period based at least in part the initial density metric, and the projected increase in density of virtual machines supported per node.

16. The computer readable medium of claim 15, wherein the set of acts comprise determining a total cost of ownership or a return on investment associated with the projected number of nodes required during the analysis period.

17. The computer readable medium of claim 15, wherein the initial density metric is further based on at least a resource available on nodes described in a database table including (i) a first column that identifies a type of resource, (ii) a second column that identifies a subtype of the type of resource identified by the first column, the subtype corresponding to a constraint on availability of the type of resource identified by the first column, and (iii) a row corresponds to a constraint in the second column and to the availability of the type of resource identified by the first column.

18. The computer readable medium of claim 15, wherein the initial density metric is based at least in part on a combination of constraints on the resource available on the nodes.

19. The computer readable medium of claim 15, wherein the set of acts further comprise determining an initial number of nodes required based at least in part on an initial number of virtual machines required to be supported and the metric.

20. The computer readable medium of claim 19, wherein the set of acts further comprise determining a total cost of ownership or a return on investment associated with a total number of nodes required in the networked virtualization system.

21. The computer readable medium of claim 15, wherein the set of acts further comprise determining a number of virtual machines currently supported based at least in part on the initial density metric and a current number of nodes.

22. The computer readable medium of claim 15, wherein the projected number of nodes comprise a number of existing nodes and a number of new nodes.

23. The computer readable medium of claim 15, wherein the nodes are for a networked virtualization environment and node density comprises numbers of virtual machines supported per node.

24. The computer readable medium of 15, wherein the projected increase in density of virtual machines supported per node is determined using a machine-learning model.

25. The computer readable medium of claim 24, wherein the machine-learning model is trained using historical information describing a number of virtual machines supported per node included in a networked virtualization system.

26. The computer readable medium of claim 19, wherein a total number of nodes required in a networked virtualization system is determined subject to two or more restrictions.

27. The computer readable medium of claim 15, wherein the set of acts further comprise determining a resource required by the networked virtualization system based at least in part on the projected number of nodes required during the analysis period.

28. The computer readable medium of claim 27, wherein the resource is selected from a group consisting of: physical space requirements of the projected number of nodes, power usage by the projected number of nodes, network requirements of the projected number of nodes, software requirements of the projected number of nodes, cooling requirements of the projected number of nodes, maintenance requirements of the projected number of nodes, and any combination thereof.

29. A computer system comprising:
a memory for storing data and instructions; and
a processor that executes a sequence of instructions which, when executed causes a set of acts, the set of acts comprising:
determining an initial density metric comprising a number of virtual machines supported by nodes for use in a networked virtualization system, the initial density metric being based at least in part on a constraint on a resource available on the nodes;
receiving information describing a projected number of virtual machines to be supported by the networked virtualization system at an end of an analysis period;
determining a projected increase in density of virtual machines supported per node at the end of the analysis period; and
determining a projected number of nodes required at the end of the analysis period based at least in part the initial density metric, and the projected increase in density metric of virtual machines supported per node.

30. The computer system of claim 29, wherein the set of acts further comprise determining a total cost of ownership or a return on investment associated with the projected number of nodes required during the analysis period.

31. The computer system of claim 29, wherein the initial density metric is further based on at least a resource available on nodes described in a database table including (i) a first column that identifies a type of resource, (ii) a second column that identifies a subtype of the type of resource identified by the first column, the subtype corresponding to a constraint on availability of the type of resource identified by the first column, and (iii) a row corresponds to a constraint in the second column and to the availability of the type of resource identified by the first column.

32. The computer system of claim 29, wherein the initial density metric is based at least in part on a combination of constraints on the resource available on the nodes.

33. The computer system of claim 29, wherein the set of acts further comprise determining an initial number of nodes required based at least in part on an initial number of virtual machines required to be supported and the initial density metric.

34. The computer system of claim 33, wherein the set of acts further comprise determining a total cost of ownership or a return on investment associated with a total number of nodes required in the networked virtualization system.

35. The computer system of claim 29, wherein the set of acts further comprise determining a number of virtual machines currently supported based at least in part on the initial density metric and a current number of nodes.

36. The computer system of claim 29, wherein the projected number of nodes comprise a number of existing nodes and a number of new nodes.

37. The computer system of claim 29, wherein the nodes are for a networked virtualization environment and node density comprises numbers of virtual machines supported per node.

38. The computer system of claim 29, wherein the projected increase in density of virtual machines supported per node is determined using a machine-learning model.

39. The computer system of claim 38, wherein the machine-learning model is trained using historical information describing a number of virtual machines supported per node included in a networked virtualization system.

40. The computer system of claim 33, wherein a total number of nodes required in a networked virtualization system is determined subject to two or more restrictions.

41. The computer system of claim 29, wherein the set of acts further comprise determining a resource required by the networked virtualization system based at least in part on the projected number of nodes required during the analysis period.

42. The computer system of claim 41, wherein the resource is selected from a group consisting of: physical space requirements of the projected number of nodes, power usage by the projected number of nodes, network requirements of the projected number of nodes, software requirements of the projected number of nodes, cooling requirements of the projected number of nodes, maintenance requirements of the projected number of nodes, and any combination thereof.
